(19) United States
(12) Patent Application Publication
(10) Pub. No.: US 2020/0274233 A1
(43) Pub. Date: Aug. 27, 2020

(54) ANTENNA MOUNT

(71) Applicant: Wireless Construction, Inc., Standish, ME (US)

(72) Inventors: Kyle Purington, Greene, ME (US); Todd Boothby, Steep Falls, ME (US); Bryan Kadrich, Gross Pointe Woods, ME (US)

(73) Assignee: Wireless Construction, Inc., Standish, ME (US)

(21) Appl. No.: 16/793,188

(22) Filed: Feb. 18, 2020

Related U.S. Application Data
(60) Provisional application No. 62/808,828, filed on Feb. 21, 2019.

(51) Int. Cl. H01Q 1/24; H01Q 1/12; F16G 11/12; H01Q 1/36

(52) U.S. Cl. CPC H01Q 1/246; H01Q 1/36; F16G 11/12; H01Q 1/1207

(57) ABSTRACT

An antenna mount for mounting a 5G antenna or other antenna to a support structure such as a utility pole or tower. The mount provides for low profile antenna attachment. The mount includes a support attachment member arranged for securing to the support structure, a first ring member arranged for coupling to the support attachment member about the support structure, and a second ring member arranged for coupling to the support attachment member about the support structure and spaced apart from the first ring member. One or more mounting plates may be secured to the first ring member and the second ring member. In an embodiment of the invention, the first ring member and the second ring member may be coupled directly to the support structure. In an embodiment, the one or more mounting plates are arranged to enable their selectable positioning on the ring members.

### BACKGROUND OF THE INVENTION

### 1. Field of the Invention

The present invention relates to mounts used to attach antennas to supports such as utility poles. More particularly, the present invention relates to an antenna mount that can be used to place one or more fifth generation (5G) configured antennas on a support. The antenna mount includes a plurality of antenna placement locations.

### 2. Description of the Prior Art

Presently, antennas such as cellular phone antennas are mounted on support structures that extend 100 feet or more from the surface. They are mounted using mounting brackets. It is important that the antenna be aligned as accurately as possible to ensure optimization of signal exchange. It is difficult to do that at the heights involved. Also, given governmental regulations that restrict the height of the combination of support structure and antenna, the antenna is preferably located as close to the top of the support as possible so as not to exceed height limits of the combination. Antennas have primarily been installed on utility poles or existing tall utility structures. Advancements in antenna functionality have led to the current 5G antenna configuration, which is typically a rectangular block rather than a single pole or a multi-leg extension configuration. These 5G antennas are preferably positioned as close to the top of the support structure as possible and are provided with adjustment brackets that are easy to access to ensure proper antenna alignment once installed on the support.

What is needed is a 5G antenna mount configured to enable adjustment of the antenna on its support so that the antenna can aligned in a desired position. Further, what is needed is a 5G antenna mount that enables the convenient mounting of a plurality of 5G antennas thereon. What is also needed is such an antenna mount that is relatively low profile to minimize the overall height of the antenna and its support. The antenna mount should be relatively easy to use and maintain in the environments where it is expected to be used.

### SUMMARY OF THE INVENTION

It is an object of the present invention to provide a 5G antenna mount configured to enable adjustment of an antenna such as a cellular signal transmission/reception antenna on its support so that it is aligned in a desired position. It is also an object of the present invention to provide a 5G antenna mount that is configured to permit mounting of a plurality of antennas thereon. It is a further object of the present invention to provide such an antenna mount that is relatively low profile to minimize the overall height of the antenna and its support. The antenna mount is designed to be relatively easy to use and maintain so that it can be placed on the support structure and keep the antenna in a desired alignment under expected weather conditions.

These and other objects are achieved with the present invention, which is a 5G antenna mount that enables relatively easy alignment of the antenna on its support. It also enables relatively low-profile placement of the antenna on the support so that the antenna is located a small distance from the top of the support without compromising the ability to align the antenna where desired. The 5G antenna mount is arranged for removable attachment of a plurality of 5G antennas thereon. The present mount helps with antenna concealment and provides a stable mount for antenna optimizations.

The mount of the present invention includes a support attachment member that is removably joined to the support as a structural component, a first ring member and a second ring member that are coupled to the support attachment member. The support attachment member may optionally be coupled to a top antenna alignment device of the type described in U.S. Pat. No. 9,620,845, the content of which is incorporated herein by reference. The first ring member and the second ring member are selectably spaced from one another and positioned about the support member, such as a utility pole but not limited thereto. The first ring member and the second ring member are each also configured to include one or more 5G antenna attachment sites. When there is a plurality of such attachment sites, the sites are spaced from one another sufficient to ensure that adjacent 5G antennas mounted thereon are spaced from one another in a manner consistent with optimum antenna function. Two examples of mounts are disclosed more fully herein.

A method of installing one or more 5G antennas on a support structure using the mount of the present invention is straightforward. First, the support attachment member is secured in a selectable position on the support structure. That position may be near the top of the support structure. The support attachment member may be formed as a sleeve extending about the support structure, or as a flat or curved plate or plates of generally rectangular configuration with the longer dimension extending parallel to the support structure. Second, the two ring members are removably attached to the support attachment member. It is contemplated that the first ring member and the second ring member may be connected to the support structure directly rather than indirectly through the support attachment member. It is also contemplated that there may be more than two ring members. Third, one or more 5G antennas are removably coupled to the first ring member and the second ring member at desired positions about the support structure. The one or more 5G antennas may be coupled to the ring members using brackets that allow adjustment of the antennas so that at least an upper region of an antenna may be spaced farther from the support structure than a lower region of the antenna.

The mount of the present invention may be positioned at or near the top of the support structure to minimize overall height of the antenna system. The support attachment member and the ring members may be fabricated of relatively inexpensive materials such as steel, aluminum or other metallic and non-metallic materials. The use of the present 5G antenna mount facilitates antenna placement, alignment and securing, thereby improving the installation process and any adjustment or maintenance efforts that may be required.

These and other advantages of the present invention will be further recognized upon review of the following detailed description, accompanying drawings and appended claims.

### BRIEF DESCRIPTION OF THE DRAWINGS

FIG. 1 is a top perspective view of a first embodiment of the 5G antenna mount of the present invention.

FIG. 2 is a top view of the 5G antenna mount of FIG. 1 showing three 5G antennas coupled thereto.

FIG. 3 is an exploded perspective view of the first embodiment of the 5G antenna mount of the present invention.

FIG. 4 is a top perspective view of a second embodiment of the 5G antenna mount of the present invention and an optional support attachment member.

FIG. 5 is a side perspective view of the 5G antenna mount of FIG. 4.

### DETAILED DESCRIPTION OF THE INVENTION

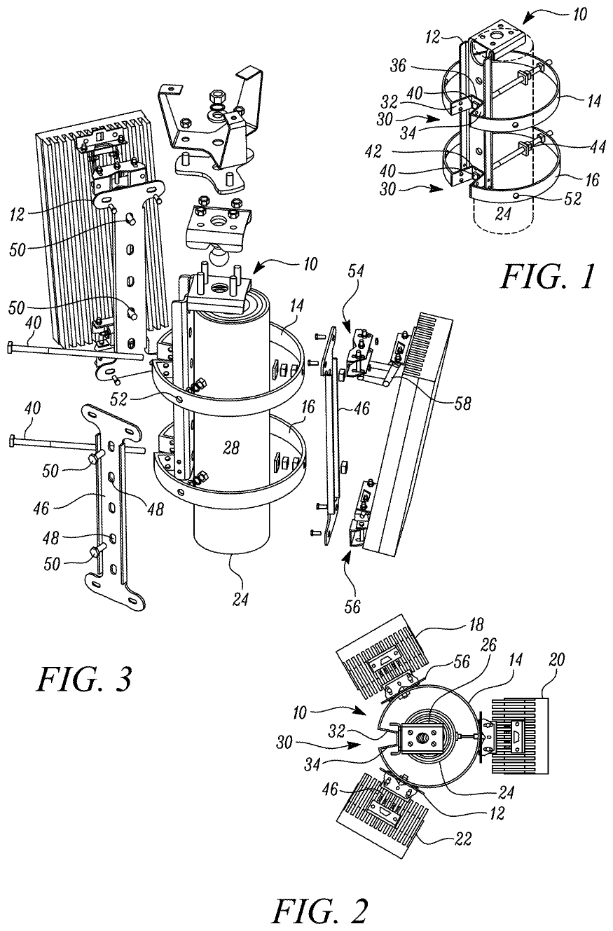

A first embodiment of a 5G antenna mount 10 of the present invention is shown in FIGS. 1-3. The mount 10 includes a support attachment member 12, a first ring member 14 and a second ring member 16. The mount 10 is configured to affix one or more 5G antennas 18, 20 and 22 to an antenna support structure 24, which may be a utility pole, for example. The mount 10 is an interface between the antennas 18-22 and the support structure 24 in a way that facilitates antenna attachment and placement. The mount 10 may include an optional support top attachment plate 26 that can be used to join a top-mounted antenna to the support structure 24.

The mount 10 is described herein as a mount suitable for mounting a 5G antenna to a support structure. It is to be understood that other structures including other antennas may be mounted to a support structure using the ring members 14 and 16 as well as the support attachment member 12 described.

The support attachment member 12 is shown as a flat plate having a plurality of attachment ports 28 extending therethrough. The support attachment member 12 is not limited to that configuration although it does require the attachment ports 28. Each of the first ring member 14 and the second ring member 16 is an annular configuration with a mounting inset 30 formed of a first inwardly angled member 32 and a second inwardly angled member 34 joined together at mount interface 36. The mount interface 36 includes an attachment port 38 through which a ring attachment member 40 in the form of a bolt or other coupling element passes. The ring attachment member 40 also passes through one of the attachment ports 28 of the support attachment member 12 and corresponding aligned ports 42 and 44 of the support structure 24.

The ring attachment member 40 is then engaged with an opposing section of the ring member 14/16 at an opposing attachment port 38 of the ring member 14/16. Both ring members 14 and 16 are attached to the support attachment member 12 and the support structure 24 in this way. Alternatively, the ring members 14 and 16 may be attached directly to the support structure 24 through the aligned ports 42 and 44. The positioning of each of the first ring member 14 and the second ring member 16 about the support structure 24 is selectable based upon the particular attachment ports 28 of the support attachment member 12 and/or aligned ports 42/44 of the support structure 24 are chosen for the ring member attachment locations.

Once the first ring member 14 and the second ring member 16 are coupled to the support structure 24, the one or more 5G antennas 18-22 may be coupled to the ring members 14 and 16. In particular, an antenna mounting plate 46 is a mounting interface between the ring members 14/16 and the antennas 18-22. Each mounting plate 46 includes a plurality of mounting ports 48 through which a plurality of mounting couplings 50 pass to engage with and be removably connected to at ring mounting ports 52 of each of the ring members 14 and 16. Each mounting plate 46 is coupled to each of the ring members 14 and 16. The 5G antennas 18-22 are then connected to the mounting plates 46. The antenna mount attachments 54 and 56 may include as an upper one of the two antenna mount attachments a hinged coupling 58 that enables the mounting of the antenna 18-22 at a downwardly facing angle when coupled through the mount 10 to the support structure 24. Conventional bolts may be used to removably couple together the components described herein.

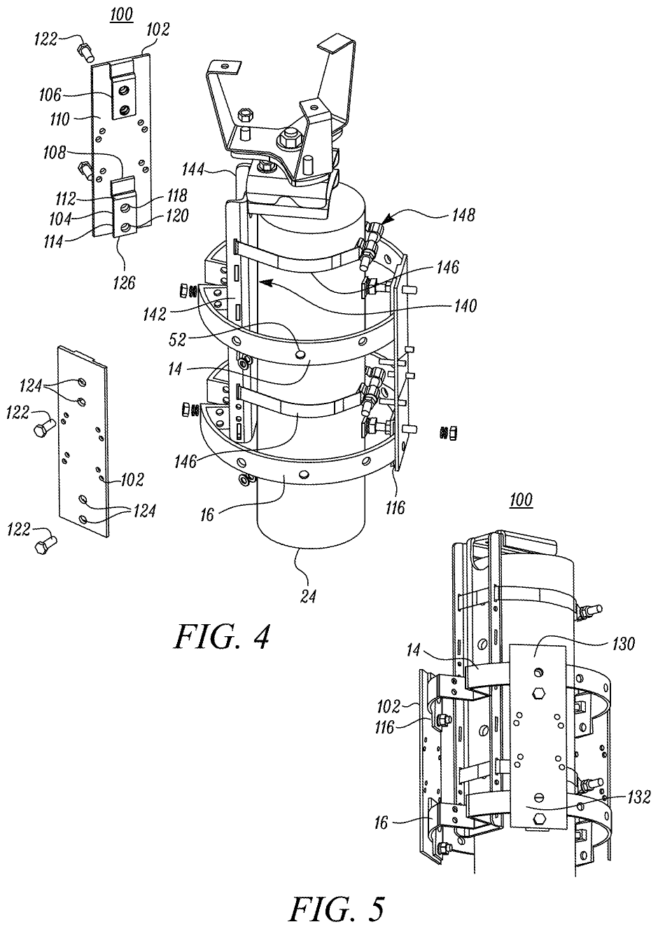

A second embodiment of a 5G antenna mount 100 of the present invention is shown in FIGS. 4 and 5. Those elements of the mount 100 that are common to the mount 10 of FIGS. 1-3 are designated with the same element numbers. The mount 100 includes a mounting plate 102, a first ring member 14 and a second ring member 16. The mount 100 is configured to affix one or more 5G antennas such as antennas 18, 20 and 22 of FIGS. 2 and 3 to an antenna support structure 24, which may be a utility pole, for example. The mount 100 is an interface between the antennas and the support structure 24 in a way that facilitates antenna attachment and placement. The mount 100 may include the optional support top attachment plate 26 that can be used to join a top-mounted antenna to the support structure 24.

The mount 100 is suitable for mounting a 5G antenna to a support structure. It is to be understood that other structures including other antennas may be mounted to a support structure using the ring members 14 and 16 as well as the mounting plate 102 described.

The mounting plate 102 is a plate having a first coupling flange 104 and a second coupling flange 106. Each of the first coupling flange 104 and the second coupling flange 106 includes a first leg 108 that is affixed to interior surface 110 of the flange 104/106, a step 112 joined to the first leg and arranged to be angled away from the interior surface 110 of the flange 104/106, such as at a right angle but not limited thereto, and a slat 114 joined to the step 110 and arranged to be spaced away from the interior surface 110. The slat 114 stepped up from the interior surface 110 establishes a slot space 116. Each of the flanges 104 and 106 includes two or more joining ports 118 and 120 that extend therethrough and also through the mounting plate 102.

The slot space 116 defined by the flanges 104 and 106 is sized and arranged to enable the flanges 104 and 106 to be slid onto the first ring member 14 and the second ring member 16. When the mounting plate 102 is positioned on the ring members 14 and 16 in alignment with the ring mounting ports 52, the joining ports 118 are used to receive mounting couplings 122, wherein the mounting couplings 122 pass through the mounting plate 102 at ports 124, the joining ports 118 and the ring mounting ports 52. The mounting couplings 122 are then reversibly secured with washers and nuts, for example, so as to retain the mounting plate 102 to the first and second ring members 14 and 16.

While the mounting plate 102 may be joined to the ring members 14 and 16 at any of the ring mounting ports 52 using the joining ports 118, a user may alternatively join the mounting plate 102 to the ring members 14 and 16 at any location thereof using the joining ports 120 instead of the joining ports 118. Specifically, the slats 114 of the flanges 104 and 106 are of sufficient length that when the ring members 14 and 16 are inserted into the slot space 116 and come in contact with, or are in close proximity to, the step 112, end 126 of the slats 114 extend beyond the widths of the ring members 14 and 16 enough so that joining ports 120 are clear of the ring members 14 and 16. The mounting couplings 122 can then be reversibly secured with nuts and washers, for example, in a manner below the ring members 14 and 16 so that the ring members 14 and 16 are retained within the slot space 116 and the support attachment member 102 is thereby secured to the ring members 14 and 16, as shown at locations 130 and 132 of FIG. 5. As noted, using those joining ports 120 allows placement of the support attachment member 102 at any location on the ring members 14 and 16 and, as a result, the antenna affixed to the mounting plate 102 may be positioned substantially anywhere about the support structure 24.

An alternative support attachment member 140 shown in FIGS. 4 and 5 can be used on either the first mount 10 or the second mount 100. The support attachment member 140 does not require the inclusion of the attachment ports 28 but they may form part of the attachment member 140. Instead, the support attachment member includes a first flange 142 and a second flange 144. Each of the first flange 142 and the second flange 144 includes a plurality of strap slots 146 positioned at selectable locations along the lengths of the flanges 142 and 144. The mechanism for securing the support attachment member 140 to the support structure 24 includes one or more straps 146 that may be reversibly extended about the perimeter of the support structure 24 and through strap slots 146 of the flanges 142 and 144. Each of the one or more straps 146 engages with a ring band bolt and a clamping element 148, such as a hose clamp, for example.

The mount 100 and/or the support attachment member 140 may be used in the same manner as that of the mount 10 and its components. The mount 100 enables the effective placement and securement of an antenna such as a 5G antenna on a support structure.

While the invention has been described with specific reference to particular components of the mount 10 and the mount 100 and particular details of those components, it is to be understood that the invention includes all reasonable equivalents.

What is claimed is:

1. A mount for mounting an antenna to a support structure, the mount comprising:
a. a support attachment member arranged for securing to the support structure;
b. a first ring member arranged for coupling to the support attachment member about the support structure; and
c. a second ring member arranged for coupling to the support attachment member about the support structure and spaced apart from the first ring member,
wherein each of the first ring member and the second ring member are arranged for coupling to a mounting plate used to mount an antenna thereon.

2. The mount of claim 1 wherein the support attachment member is a flat plate including a plurality of attachment ports extending therethrough.

3. The mount of claim 1 wherein the support attachment member is a sleeve arranged for extending about the support structure when coupled thereto and including a plurality of attachment ports extending therethrough.

4. The mount of claim 1 wherein each of the first ring member and the second ring member includes an inset region for coupling each of the first ring member and the second ring member to the support attachment member.

5. The mount of claim 1 wherein the mounting plate includes a first coupling flange and a second coupling flange, wherein each of the first coupling flange and the second coupling flange is configured to enable placement of the support attachment member at a selectable location on the first ring member and the second ring member.

6. The mount of claim 1 wherein the support attachment member is reversibly bolted to the support structure.

7. The mount of claim 1 wherein the support attachment member is reversibly strapped to the support structure.

8. A mount for mounting an antenna to a support structure, the mount comprising:
a. a first ring member arranged for coupling to the support structure about the support structure; and
c. a second ring member arranged for coupling to the support structure about the support structure spaced apart from the first ring member,
wherein each of the first ring member and the second ring member are arranged for coupling to an antenna mounting plate used to mount an antenna thereon.

9. The mount of claim 5 wherein each of the first ring member and the second ring member includes an inset region for coupling each of the first ring member and the second ring member to the support structure.

10. A kit for coupling an antenna mount to a support structure, the kit comprising:
a. a support attachment member arranged for securing to the support structure;
b. a first ring member arranged for coupling to the support attachment member about the support structure;
c. a second ring member arranged for coupling to the support attachment member about the support structure and spaced apart from the first ring member;
d. an antenna mounting plate configured to retain an antenna thereon; and
e. instructions for coupling the first ring member and the second ring member to the support attachment member and for coupling the antenna mounting plate to the first ring member and the second ring member.

11. The kit of claim 10 wherein the antenna mounting plate includes a first coupling flange and a second coupling flange, wherein each of the first coupling flange and the second coupling flange is configured to enable placement of the support attachment member at a selectable location on the first ring member and the second ring member
